(19) United States
(12) Patent Application Publication
(10) Pub. No.: US 2024/0424554 A1
(43) Pub. Date: Dec. 26, 2024

(54) POWDER PRESS AND METHOD FOR POWDER-PRESSING A POWDER-PRESSED PART

(71) Applicant: DORST TECHNOLOGIES GMBH &CO. KG, Kochel am See (DE)

(72) Inventors: Walter RAU, Grossweil (DE); Michael Thomas SILBERMANN, Bichl (DE)

(21) Appl. No.: 18/687,163

(22) PCT Filed: Sep. 2, 2022
(86) PCT No.: PCT/EP2022/074430

§ 371 Date: Feb. 27, 2024

(30) Foreign Application Priority Data
Sep. 6, 2021 (DE) 10 2021 123 002.0

(51) Int. Cl. B22F 3/03; B22F 5/06; B28B 7/30; B30B 11/02

(52) U.S. Cl. CPC B22F 3/03; B22F 5/06; B28B 7/303; B30B 11/027; B22F 2998/10

(57) ABSTRACT

The invention relates to a powder press for pressing a powder-pressed part, comprising at least one first punch, which, in a pressing position, is arranged to be immersible from a first side into a cavity of a die filled with ceramic or metal powder, as well as a centre pin with an external thread for forming an internal thread in the powder-pressed part, wherein during the pressing the centre pin is arranged in the cavity and, for demoulding of the pressed part, is moved translationally via a translatory drive and is rotated about its longitudinal axis via a rotary drive such that the centre pin is moved out of the formed internal thread of the pressed part.

The invention relates to a method for powder-pressing a powder-pressed part, in particular a metal powder-pressed part, preferably a hard metal powder-pressed part, and/or a ceramic powder-pressed part, as well as to a corresponding powder press.

Powder presses or corresponding methods for powder-pressing a powder-pressed part are basically known from the prior art. In principle, it has also already been proposed to mould an internal thread in such a process. For example, CH 3 522 18 describes a process in which a punch with an extension is inserted into the powder mass without compacting the powder. The actual compaction then takes place via slide parts that compress the powder at right angles to the filling direction while the punch closes the die filling. The screw nut produced in this way is unscrewed from the projection after the pressing process.

Overall, known methods for producing threads, in particular internal threads, are considered to be comparatively complex.

It is therefore the object of the invention to propose a method for powder-pressing a powder-pressed part, in particular a metal powder-pressed part, preferably a hard metal powder-pressed part, and/or a ceramic powder-pressed part, as well as a corresponding powder press, wherein a thread, in particular an internal thread, shall be be producible in a comparatively simple and yet precise manner.

This object is solved in particular by the features of claim 1.

In particular, the object is solved by a method for powder-pressing a powder-pressed part, in particular a metal powder-pressed part, preferably a hard metal powder-pressed part, and/or a ceramic powder-pressed part and/or a plastic powder-pressed part, wherein, during pressing, a centre pin with an external thread for forming an internal thread of the powder-pressed part is arranged in a powder-filled cavity of a die of a powder press, wherein the centre pin is moved translationally via a translatory drive during demoulding of the powder-pressed part and is rotated about its longitudinal axis via a rotary drive such that the centre pin is moved out of the formed internal thread of the powder-pressed part.

One idea of the invention lies therein to drive (synchronisedly) a centre pin of the powder press in such a way that it moves both translationally and rotates about its longitudinal axis for demoulding. By this a powder-pressed part with an internal thread can be produced and demoulded in a simple manner. Preferably, the rotary drive is arranged laterally opposite the centre pin. Alternatively or additionally, a drive shaft (of the rotary drive) can run at an angle (in particular of at least 30°, preferably at least 60°, more preferably of at least approximately 90°) relative to the longitudinal axis of the centre pin. In this way, a rotary drive of the centre pin can be realised in an effective and space-saving manner.

According to embodiments, the rotary drive has at least one motor and possibly a drive shaft for driving the centre pin.

In embodiments, the centre pin is rotated during a force reduction phase after pressing, in particular into the pressed part. By this pressed parts with a high quality can be produced. By a rotation into the pressed part (i.e. actually in a direction that is exactly opposite to a demoulding direction), a corresponding powder-pressed part can be produced and demoulded in a precise yet simple manner. Alternatively, the centre pin can also be (partially) rotated out of the pressed part during a force reduction phase after pressing.

In further embodiments, the centre pin is not rotated during a (or the above) force reduction phase after pressing.

The die can be removed from the powder-pressed part before the centre pin is moved out. Alternatively, the die can (only) be removed from the powder-pressed part after the moving-out of the centre pin. Preferably, during moving-out of the centre pin of the powder-pressed part a load is generated by a second punch (in particular an upper punch). Alternatively or additionally, a holding device, in particular a gripper (e.g. on a filling shoe), can hold the powder-pressed part. By this a demoulding can take place in a comparatively simple manner.

Preferably, a bevel gear is associated with rotary drive. Alternatively or additionally, a bevel gear is associated with the centre pin (in particular complementary to the bevel gear of the rotary drive). Further preferably, the bevel gear associated with the rotary drive is arranged above the bevel gear associated with the centre pin (or arranged closer to the die than the bevel gear associated with the centre pin). In particular, if the bevel gear associated with the rotary drive is arranged above the bevel gear associated with the centre pin, it is achieved that when the centre pin is compressed, the bevel gears rather are moved away from each other than being pressed against each other, so that an efficient demoulding is made possible.

In embodiments, the centre pin can be rotated (at least in phases) during pressing. Alternatively, the centre pin is not rotated during pressing.

The above object is further solved by a powder press, in particular a metal powder and/or ceramic powder and/or plastic powder press, preferably for use in the above method, comprising a control unit, at least one first punch which, in a pressing position, is arranged to be immersible from a first side into a cavity of a die to be filled with ceramic and/or metal powder, as well as a centre pin with an external thread for forming an internal thread in the powder-pressed part, which can be moved back and forth translationally via a translatory drive and can be rotated about its longitudinal axis via a rotary drive, wherein the control unit is configured to control the translatory drive and the rotary drive in dependence of the internal thread of the powder-pressed part to be pressed in such a synchronised manner that the centre pin can be moved out of the formed internal thread of the powder-pressed part after the pressing process.

Preferably, the rotary drive is arranged laterally opposite the centre pin. Alternatively or additionally, a drive shaft (of the rotary drive) runs at an angle, in particular of at least 30°, preferably at least 60°, more preferably at least approximately 90° relative to the longitudinal axis of the centre pin.

A bevel gear associated with the rotary drive is preferably arranged above a bevel gear associated with the centre pin (or arranged closer to the die than the bevel gear associated with the centre pin).

The control unit is preferably configured to cause the press to perform the above method.

The control unit preferably comprises at least one processor, at least one (electronic) memory and at least one input and/or output unit. The control unit may be integrated into a control unit for controlling the pressing process or be configured separately to such a control unit or be at least partially integrated into such a control unit.

The above method or the above press is preferably used for forming metal powder-pressed parts, further preferably hard metal powder-pressed parts, such as drill bits with internal threads (with or without shoulder), or a cutting bit with internal threads.

The powder press can preferably be configured for a maximum pressing pressure of at least 1 tonne or at least 10 tonnes or at least 20 tonnes, possibly at least 50 tonnes or at least 100 tonnes.

A pitch angle of the internal thread is preferably at most 30°, further preferably at most 20°, optionally at most 10° or at most 5° or at most 3° and/or at least 0.1°, optionally at least 1°.

The rotary drive preferably has an (electric) servomotor.

A powder-pressed part height can be at least 10 mm, preferably at least 30 mm and/or at most 120 mm, possibly at most 70 mm. The internal thread can be an internal thread of type M4 or higher and/or M10 or lower. A thread pitch can be at least 0.1, preferably at least 0.2 and/or at most 2.0, preferably at most 1.5. The internal thread can be single or multi-start. Furthermore, the internal thread can be designed to rotate clockwise or anti-clockwise.

The powder can be metal powder (especially hard metal powder), ceramic and/or one or more plastic(s).

The rotary drive can have a height of at least 100 mm and/or at most 300 mm. Furthermore, the rotary drive can have a diameter of at least 60 mm and/or at most 100 mm.

The rotary drive can be configured for a maximum torque of at least 3 Nm or at least 7 Nm and/or at most 10 Nm.

The entire pressing cycle (including removal of the powder-pressed part or green body) preferably takes less than 10 seconds or less than 5 seconds and/or at least 1 second or at least 2 seconds. The time for the removal of the powder-pressed part or the removal of it from the centre pin preferably takes less than 2 seconds or less than 1 second and/or at least 0.2 seconds.

Preferably, a rotary movement (due to the rotary drive) is synchronised with a linear movement of the centre pin such that a demoulding of the powder-pressed part (or green body) according to the thread pitch is made possible.

Alternative to the lateral arrangement of the rotary drive, the rotary drive can also be arranged directly below the centre pin.

Further embodiments are shown in the dependent claims.

The invention is described below with reference to example embodiments, which are explained in more detail with reference to the drawings. These show:

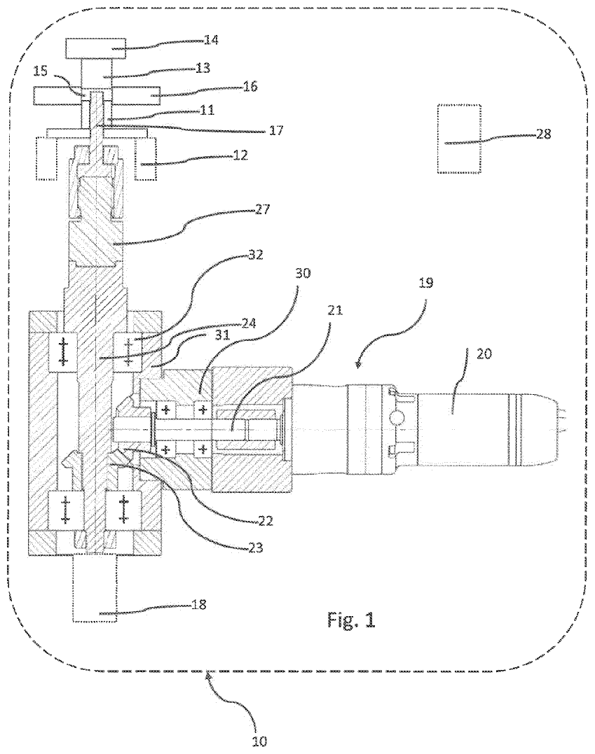

FIG. 1 a powder press according to the invention in schematic representation, with details of the drive of a centre pin shown in section;

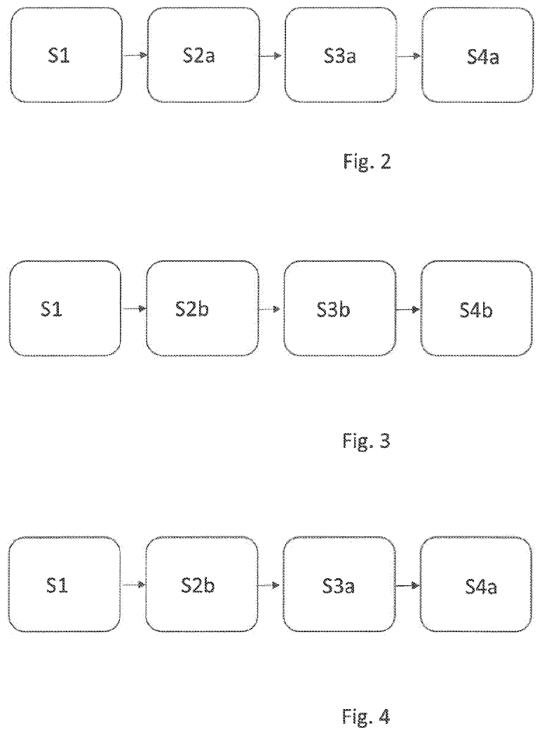

FIG. 2 a schematic representation of a pressing method according to a first embodiment;

FIG. 3 a schematic representation analogous to FIG. 2 according to a further embodiment, and

FIG. 4 a representation according to FIG. 2 in a further embodiment.

In the following description, the same reference numerals are used for identical and identically acting parts.

FIG. 1 shows in a partially (highly) schematic view an embodiment of a powder press 10 with details in the area of a drive mechanism for a centre pin 17 in detail.

The powder press 10 comprises (only shown schematically) a lower punch 11, which can be driven via a lower punch drive 12, an upper punch 13, which can be driven via an upper punch drive 14, as well as a die 15 with a cavity 16 (which can be filled with powder).

Furthermore, in FIG. 1 the centre pin 17 is shown, which can be moved translationally (in axial direction or in and against the pressing direction) via a lift drive or translatory drive 18 (only shown schematically). Furthermore, the centre pin 17 can be rotated about its longitudinal axis via a rotary drive 19. The centre pin also has an external thread (not shown) in order to form a corresponding internal thread in a pressed part (not shown).

The rotary drive 19 comprises a motor (20), preferably with an integrated shaft encoder (or angle transmitter), a drive shaft 21 as well as a first bevel gear 22. In turn, via motor 20, drive shaft 21 and first bevel gear 22 a second bevel gear 23 can be driven, via which a centre pin shaft 24 can be rotated, so that the centre pin 17 (which is optionally connected here to the centre pin shaft 24 via an adapter part 27, whereby the adapter part can also be regarded here as a component of the centre pin shaft) can also be rotated.

The powder press 10 also has a control unit 28, which is configured to control the lift drive 18 as well as rotary drive 19 in a synchronised manner so that, in particular, the a demoulding of the powder-pressed part from the centre pin 17 can take place. For this purpose, the rotation of the centre pin (17) is adapted to the linear movement in accordance with the external thread of the centre pin (or internal thread of the pressed part) (or vice versa).

The motor 20 and the drive shaft 21 are connected to a centre pin holder 31 via a (housing-like) fastening device 30. The centre pin shaft 24 is rotatably mounted within the centre pin holder 31, preferably (as in the present embodiment example, although this is not mandatory) via corresponding ball bearings 32.

FIG. 2 shows the pressing method in a schematic representation. In a step S1, the powder-pressed part is pressed. At the end of the step S1, the centre pin is located in the cavity of the die. In a step S2a, a force reduction takes place. At the same time, a cushioning with the die occurs. The centre pin also performs a cushioning movement with a (synchronised) rotational movement into the powder-pressed part (during the cushioning movement). In a step S3a the die is removed. In a step S4a, an axial removal movement of the centre pin takes place, which is synchronised with a rotational movement (out of the powder-pressed part).

An alternative process sequence is shown in FIG. 3. The step S1 corresponds here to the step S1 according to the process of FIG. 2. Step S1 is followed by a step S2b, in which a force reduction takes place. At the same time, a cushioning with the die occurs as well as a cushioning movement of the centre pin. During the step S2b, no rotational movement of the centre pin (during the cushioning movement) takes place. In a step S3b, a removal movement of the centre pin takes place (synchronised with a corresponding rotational movement). In a step S4b, a removal of the die takes place.

A further embodiment of the method is illustrated in FIG. 4. Step S1 corresponds here to the step S1 according to FIGS. 2 and 3. Step S2b corresponds to the step S2b according to FIG. 3. The step S2b is followed by a step S3a, which corresponds to the step S3a according to FIG. 2. The step S3a is followed by a step S4a, which corresponds to the step S4a according to FIG. 2.

At this point, it should be pointed out that all the parts described above are claimed as essential to the invention when viewed individually and in any combination, in particular the details shown in the drawings. Modifications thereof are familiar to the skilled person.

Furthermore, it is pointed out that the a scope of protection as broad as possible is sought. In this respect, the invention defined in the claims can also be specified by features that are described with further features (even without these further features necessarily being included). It is explicitly pointed out that round brackets and the term “in particular” are intended to emphasise the optional nature of features in the respective context (which does not mean, conversely, that a feature is to be regarded as mandatory in the corresponding context without such identification).

### REFERENCE SIGNS

10 press (powder press)

11 lower punch

12 lower punch drive

13 upper punch

14 upper punch drive

15 die

16 cavity

17 centre pin

18 lift drive (translatory drive)

19 rotary drive

20 motor

21 drive shaft

22 first bevel gear

23 second bevel gear

24 centre pin shaft

27 adapter part

28 control unit

30 fastening device

31 centre pin holder

32 ball bearing

1. A method for powder-pressing a powder-pressed part, in particular metal powder-pressed part, preferably hard metal powder-pressed part, and/or ceramic powder-pressed part and/or plastic powder-pressed part, wherein during the pressing a centre pin with an external thread for forming an internal thread of the powder-pressed part is arranged in a powder-filled cavity of a die of a powder press, wherein the centre pin is moved translationally via a translatory drive during demoulding of the powder-pressed part and is rotated about its longitudinal axis via a rotary drive such that the centre pin is moved out of the formed internal thread of the powder-pressed part.

2. The method according to claim 1, wherein the rotary drive is arranged laterally opposite the centre pin and/or a drive shaft runs at an angle of at least approximately 90°, relative to the longitudinal axis of the centre pin.

3. The method according to claim 1, wherein the centre pin is rotated during a force reduction phase after the pressing, in particular into the powder-pressed part.

4. The method according to claim 1, wherein the centre pin is not rotated during a force reduction phase after the pressing.

5. The method according to claim 1, wherein the die is removed from the powder-pressed part before the centre pin is moved out.

6. The method according to claim 1, wherein the die is removed from the powder-pressed part after the centre pin is moved out.

7. The method according to claim 1, wherein during the moving out of the centre pin, a load is generated by a punch which holds the powder-pressed part.

8. The method according to claim 1, wherein a first bevel gear associated with the rotary drive is arranged above a complementary bevel gear associated with the centre pin or is arranged closer to the die than the complementary bevel gear.

9. The method according to claim 1, wherein the centre pin is rotated during the pressing.

10. A powder press, in particular metal powder and/or ceramic powder and/or plastic powder press, preferably for use in a method for powder-pressing a powder-pressed part, the press comprising a control unit, at least one first punch, which is arranged in a pressing position to be immersible from a first side into a cavity of a die to be filled with powder, and a centre pin with an external thread for forming an internal thread in the powder-pressed part, which can be moved axially via a translatory drive and can be rotated about its longitudinal axis via a rotary drive, wherein the control unit is configured to control the translatory drive and the rotary drive in dependence of the internal thread of the powder-pressed part to be pressed in such a synchronised manner that the centre pin can be moved out of the formed internal thread of the powder-pressed part after the pressing process.

11. The press according to claim 10, wherein the rotary drive is arranged laterally opposite the centre pin and a drive shaft runs at an angle of at least approximately 90°, relative to the longitudinal axis of the centre pin.

12. The press according to claim 10, wherein a first bevel gear associated with the rotary drive is arranged above a complementary bevel gear associated with the centre pin or is arranged closer to the die than bevel the complementary bevel gear.

13. The press according to claim 10, wherein the control unit is configured to cause the press to perform the method for powder-pressing the powder-pressed part.
